(19) United States
(12) Patent Application Publication
(10) Pub. No.: US 2019/0373860 A1
(43) Pub. Date: Dec. 12, 2019

(54) LIGHTWEIGHT DOG HARNESS WRAP

(71) Applicant: Liy Kath, San Francisco, CA (US)

(72) Inventor: Liy Kath, San Francisco, CA (US)

(21) Appl. No.: 16/003,112

(22) Filed: Jun. 8, 2018

(51) Int. Cl. A01K 27/00; A01K 13/00; B60R 22/10

(52) U.S. Cl. CPC A01K 27/002; B60R 22/10; A01K 27/005; A01K 13/006

(57) ABSTRACT

A lightweight dog harness wrap for providing a secure, comfortable leash connection to a small to medium size dog. The harness wrap is comprised of a durable and reversible fabric material shaped to wrap around the torso and neck areas of the dog and is preferably secured and adjusted with Velcro. A nylon webbing strap handle is provided on the harness wrap and arranged longitudinally along the dog's back for lifting up the dog. Of particular importance is the location of the leash connection point at the rear of the harness wrap and located in the middle of the dog's torso and at the center of mass. By locating the leash connection in the middle of the dog's body, the leash pulling forces are distributed and dissipated at the dog's torso in order to eliminate harmful forces at the neck, choking and potential trachea damage, as well as damage to the hips from torquing at the neck. The dog is more balanced during walking. The harness wrap's advanced material and fabrics regulate the dog's body temperature by providing both warming and cooling properties. Nervous or anxious dogs are calmed with a feeling of protection and security with the harness wrap's swaddle-fit enclosure.

### BACKGROUND

Conventional dog collars and leash systems focus leash pulling and arresting forces at the dog's neck. Repetitive force at the dog's neck can damage the trachea and torque the body around, stressing the hip joints. A more comfortable and physiologically humane method is to utilize a leash and harness system for dissipating forces across the dog's body and torso and to avoid concentrating harmful forces at the neck. Dog's that exhibit nervousness or anxiety may additionally benefit from a harness enclosure which provides a secure, swaddle-fit enclosure and protective feeling.

Similar to the system and methods of U.S. patent application Ser. No. 15/798,403 Dog Harness with Integrated Support Handles and Load Distribution Geometry, the present application provides a dog harness for more humane control and even distribution of leash pulling forces at the dog's torso and center of mass, instead of at the neck. However, the present application provides a lightweight and more simple solution, intended for medium to smaller size dogs. A woven fabric harness with load distribution form-factor integrated to the dog's body is provided with integrated handles and leash connection points, webbing straps, and load dissipating geometry across the chest and torso area.

The harness may comprise a durable and reversible fabric material shaped to wrap around the torso and neck areas of the dog and may be preferably fitted and secured with Velcro. A hand hold may be provided as a nylon webbing or other strap along the top of the harness wrap for lifting and controlling the dog. A D-ring leash connection point may be preferably located along the top rear of the harness at the dog's center of mass. The rearward located leash connection point distributes and dissipates leash pulling forces at the dog's torso and eliminates pulling at the neck with a choke-free design for preventing trachea and hip damage.

### SUMMARY

The presently described lightweight dog harness wrap provides a more comfortable means of securing a leash to a medium to small sized dog and evenly distributes force across the dog's torso and center of mass with a choke-free design which prevents neck injury and trachea damage and provides a more balanced dog walking experience. The dog harness wrap is preferably constructed with a durable and reversible woven fabric material for fitting to a small to medium size dog. The harness wrap is easily secured and fitted to the dog by fully wrapping around the neck and wrapping around the dog's chest and torso area and may be preferably secured with Velcro connection points located under the neck and under the chest. A leash connection point is located at the rear of the harness along the dog's back and in the middle of the body and center of mass for even load distribution across the dog's torso. The leash connection point may additionally be used to secure the dog to an automobile seat belt. An emergency handle nylon webbing strap may preferably be integrated into the top of the harness running along the dog's back and may provide a hand hold for the dog owner to lift and control the dog. The minimalist design of the harness wrap provides the dog owner with a user-friendly system for attaching a leash and distributing leash pulling forces and loads across the dog's body and thereby eliminates harmful repetitive forces at the neck, trachea, and torquing forces on the hips. The harness wrap may preferably be constructed with advanced materials for regulating the dog's body temperature in hot or cold environments. Nervous or anxious dog's are calmed with the harness wrap's secure and enclosed swaddle-fit feeling. The lightweight dog harness wrap is preferably available in sizes starting from teacup: chest 17-inches, neck 11.5-inches; extra small: chest 19.75-inches, neck 14.5-inches; small: chest 21.5-inches, neck 15-inches; medium: chest 25-inches, neck 18.5-inches; and large: chest 27.5-inches, neck 20.5 inches; and other alternative sizes may be available.

### DESCRIPTION OF THE DRAWINGS

FIG. 1 is a view of the lightweight dog harness wrap secured and fitted to a medium sized dog with the leash pulling forces distributed across the harness and dissipated at the dog's center of mass, torso, and chest area.

FIG. 2 provides side profile views of the lightweight dog harness wrap being worn by a medium size dog with a leash secured at the connection point at the dog's middle torso center of mass area.

FIG. 3 is a front facing underside view of a dog standing and wearing the lightweight dog harness wrap secured with Velcro at the chest and neck areas.

FIG. 4 is a birds eye view looking down at a medium sized dog wearing the lightweight dog harness wrap with nylon webbing support running along the dog's back and metal D-ring leash connection point at the rear of the harness at the dog's center of mass middle torso area.

FIG. 5 is a view of the lightweight dog harness wrap form-factor, shaped fabric design for wrapping around the dog's torso and chest areas and distributing load across the dog's body at the center of mass; also visible is the harness Velcro connection points, nylon webbing, and metal D-ring leash connection point.

FIG. 6 is a view of the reversible side of the lightweight dog harness wrap form-factor, shaped fabric design for wrapping around the dog's torso and chest areas and distributing load across the dog's body at the center of mass; also visible are the Velcro connection points, nylon webbing, and metal D-ring leash connection point.

FIG. 7 is a view of the lightweight dog harness wrap sizing chart for teacup, extra small, small, medium and large size dogs; the harness wrap is sized based on chest and neck measurements.

### DETAILED DESCRIPTION

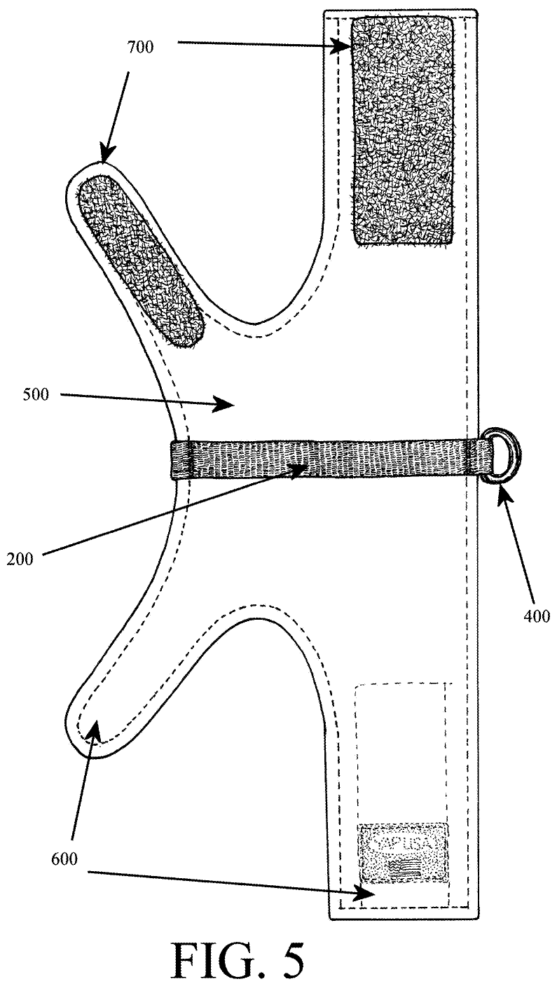

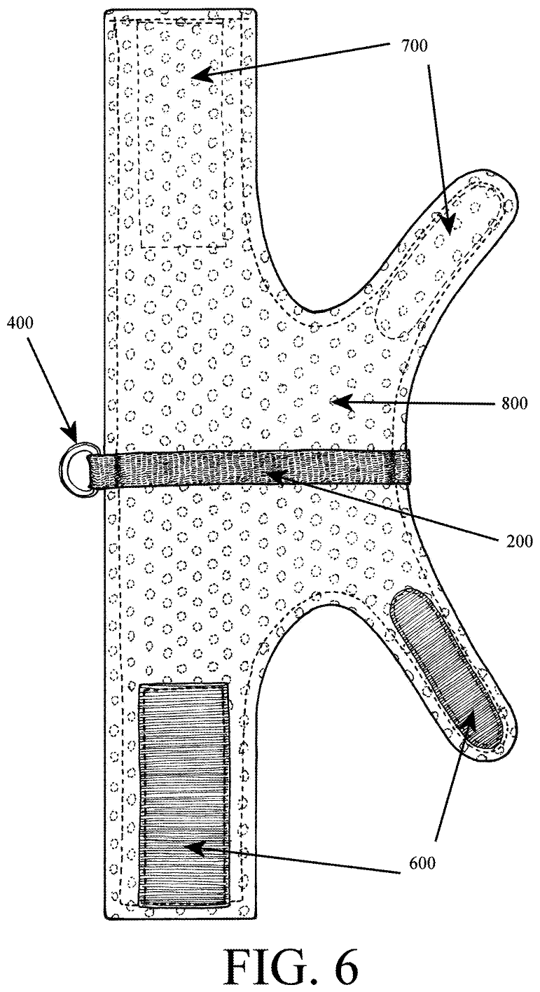

The lightweight dog harness wrap is preferably manufactured from a durable synthetic or natural woven fabric material that is washable and designed to be weight bearing for typical loads encountered during restraint of the owner's dog. FIG. 5 and FIG. 6 are preferred embodiments of the lightweight harness wrap form-factor shaped fabric design. The harness wrap is preferably manufactured with a durable woven nylon, mesh fabric, waterproof synthetic material, canvas, leather, plaid patterned (i.e., diamond plaid, or classic paid in colors: green/yellow, red/yellow, purple/blue, red/blue), floral patterned (i.e., paisley, Hawaiian, etc.), striped patterned, solid color patterned, camouflage patterned, animal print patterned (i.e., python, cheetah, leopard, zebra, etc.), sports team colors patterned, padded, fleece, cold weather, breathable, anti-static, light warm weather, or other organic or synthetic fabric materials and combinations.

The harness wrap material and fabric are shaped and cut to preferably follow the form-factor design in FIG. 5 and FIG. 6 in order to fully wrap around the dog's torso and neck areas with fabric parts 600 and 700. The larger square shaped cutout of the harness wrap shape is preferably designed to wrap around the dog's torso, chest and back areas and be secured with Velcro, and also provides the leash connection point 400. The smaller, rounded and angled forward shapes of the harness are designed to wrap around the dog's neck and also be secured with Velcro. In totality, the design preferably comprises a one-piece X-shaped form factor, chest and torso area wrapping load distribution geometry, with integrated center of mass leash connection point 400 and webbing strap handle 200. The four points 600, 700 of the harness wrap's X-shape preferably function to fully wrap around the dog's middle torso and neck areas and are secured with Velcro. The lightweight harness wrap design is therefore very easy for the dog owner to secure and fit to their dog by wrapping around the chest and neck areas and securing with Velcro attachment points. Other alternative embodiments of the lightweight harness wrap may be secured with plastic nylon buckles, nylon webbing straps, and Velcro connection points.

The harness wrap fabric material is preferably designed to be durable, washable, reversible and load bearing in order to provide load distribution functionality and dissipate harness loads across the dog's torso, and chest areas. The harness wrap stitching along the edges is preferably embodied in a load bearing design securing an inside and outside fabric material together to form the shaped, lightweight harness form-factor design of FIG. 5 and FIG. 6. The harness stitching additionally and securely integrates the Velcro attachment points 600 and 700, webbing strap handle 200, leash connection point 400, and preferably includes the “YAP USA” brand product labeling to provide the owner with knowledge that the harness wrap is a high quality dog harness, designed and manufactured in the USA by YAP Stores of San Francisco, Calif.

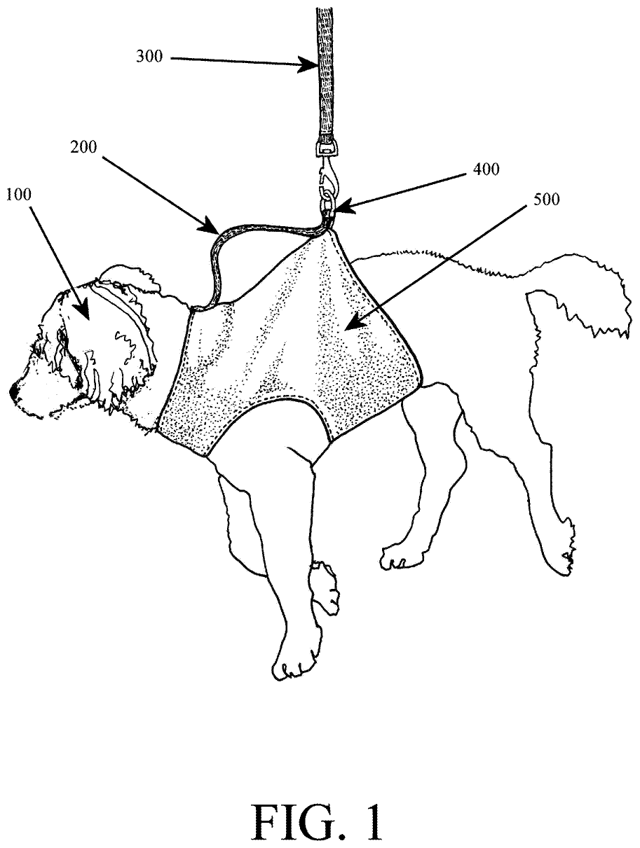

The leash connection point is preferably constructed with a metal ring or metal D-ring connection point 400 secured by a woven fabric webbing strap handle 200 integrated along the length of the harness wrap and designed to provide load distribution of the leash pulling forces, and forces exerted on the webbing strap 200, across the woven fabric areas of the harness wrap. In FIG. 1, the dog 100 is being lifted up at the leash connection point 400 and loads are being distributed across the lightweight dog harness wrap 500 at the dog's center of mass, chest and torso areas. The choke-free design prevents neck and trachea damage and additionally avoids torquing the dog around the neck and repetitively stressing the hip joints. The fabric webbing strap 200 additionally provides an emergency handle or hand hold for the dog owner to pick up and control the dog. Forces exerted on the handle 200 are distributed across the harness at the dog's center of mass, torso, and chest areas. The harness wrap webbing strap handle 200 is secured by reinforced stitching at the front and rear of the harness wrap. The webbing strap handle may preferably be rated to handle up to 100-pounds of pulling force. The harness wrap regulates body heat in hot or cold environments and provides nervous or anxious dogs with a calming, secure swaddle-wrap protective feeling.

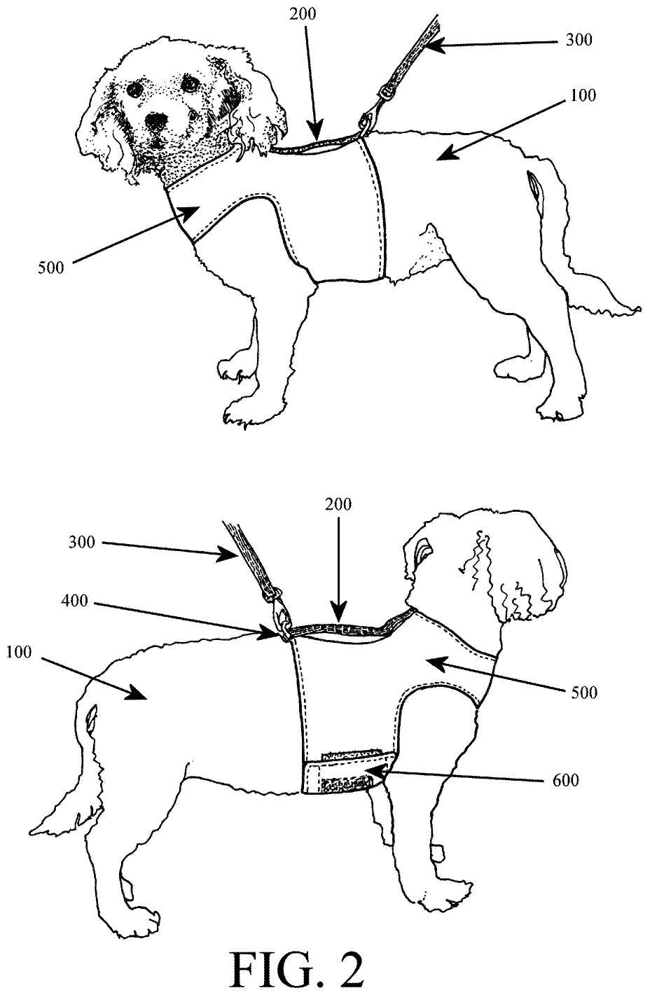

In FIG. 2, the dog 100 is outfitted and secured in the lightweight dog harness wrap 500. The dog appears calm and protected from the elements with the secure feeling provided by the harness wrap enclosure. The harness wrap is secured along the dog's chest area with Velcro connection point 600. The dog owner may lift up and control the dog with the fabric webbing strap handle 200 running along the back of the harness wrap. The leash connection point 400 is preferably embodied in a metal D-ring design for clipping on a conventional leash 300. The harness wrap 500 dissipates leash pulling forces across the dog's center of mass, chest and torso areas and provides a choke-free design which prevents neck and trachea damage.

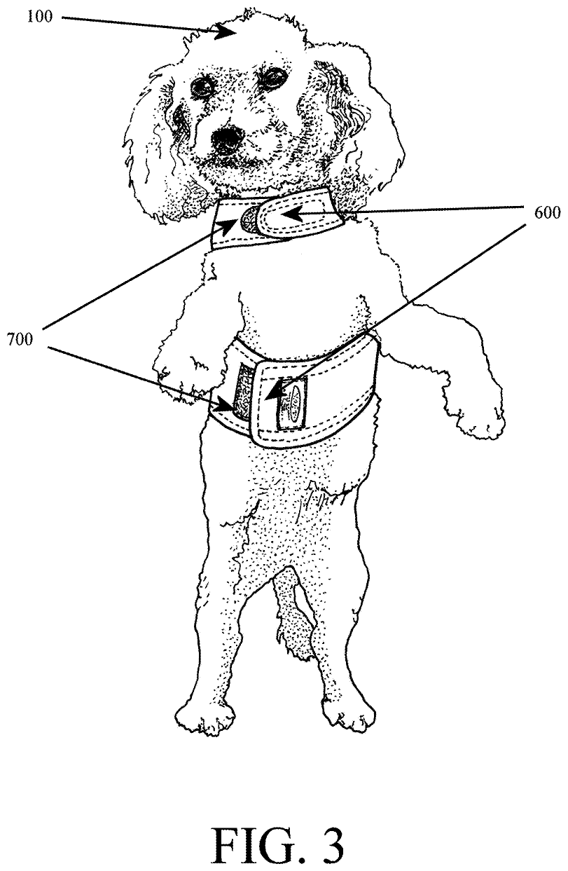

In FIG. 3, the dog 100 is being humanely restrained with the lightweight dog harness wrap. Leash pulling forces are dissipated across the dog's center of mass, chest and torso areas with the harness load distribution geometry. The harness is comfortably secured with Velcro attachment points at the dog's chest and neck areas 600, and 700. The connection points 600, 700 allow the dog owner to easily put on and outfit the dog with the reversible, lightweight dog harness wrap and provide the dog with cold or warm weather protective gear. The harness design provides choke-free control of the dog 100 and prevents neck and trachea damage. The dog 100 is protected from harm and is humanely controlled and restrained with the lightweight dog harness wrap load distribution geometry. Additionally, nervous or anxious dogs are calmed and comforted with the harness wrap, secure swaddle-fit enclosure.

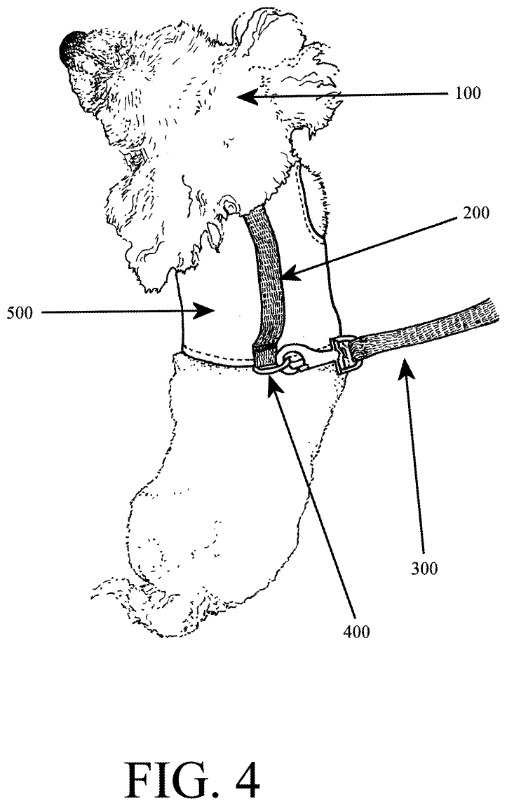

In FIG. 4, the dog 100 is walking and comfortably secured in the lightweight dog harness wrap 500. The owner may control the dog with the leash 300 clipped to the leash connection point metal D-ring 400. Leash pulling forces are distributed across the dog's center of mass, chest and torso areas.

FIG. 5 and FIG. 6 illustrate preferred form-factor embodiments of the lightweight dog harness wrap design. The harness wrap is preferably reversible and may embody a solid color design as shown in FIG. 5 with an alternative patterned design in FIG. 6 and may be worn with either side facing out. The harness wrap materials may preferably be embodied in synthetic or organic materials (i.e., nylon, canvas, suede, fleece, cotton, corduroy, leather, mesh, etc.) that are soft, durable, washable and breathable.

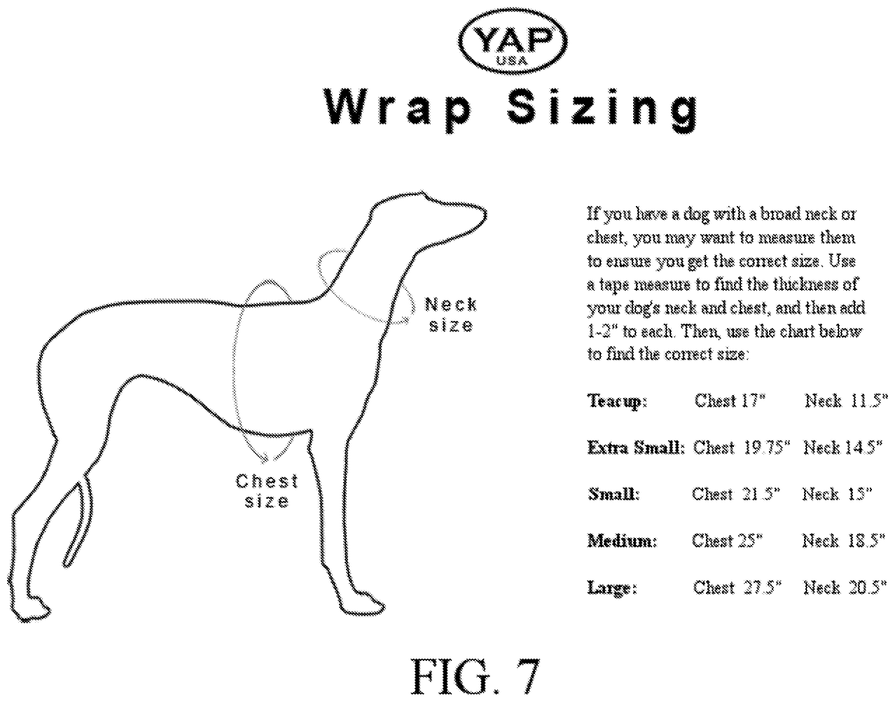

In FIG. 7, the lightweight dog harness wrap sizing chart is provided for properly sizing the harness to teacup, extra small (XS), small (S), medium (M), and large (L) size dogs. Sizing is measured at the chest and neck. Alternative sizes may also be available.

1. A lightweight dog harness wrap comprising:
a one piece X-shaped form-factor woven fabric harness with fully wrapping chest and torso area load distribution geometry;
an integrated center of mass leash connection point; and
an integrated webbing strap handle;
wherein the four points of the X-shaped form factor harness wrap around the dog's middle torso and neck areas and are secured with Velcro; wherein leash pulling forces are dissipated across the dog's center of mass, torso and chest areas and thereby eliminating choking at the neck; and wherein the harness wrap is constructed out of a durable, reversible, woven fabric, load bearing material for regulating the dog's body temperature in hot or cold environments and providing a secure, swaddle-fit enclosure for calming and protecting nervous or anxious dogs.

2. The lightweight dog harness wrap of claim 1, wherein the four points of the harness X-shaped form-form factor design comprise two larger square shaped pieces which wrap around the dog's torso, chest and back areas and are secured with Velcro; and two smaller rounded angled forward shaped pieces which wrap around the dog's neck and are secured with Velcro.

3. The lightweight dog harness wrap of claim 1, wherein the integrated center of mass leash connection point comprises a metal D-ring located at the top rear of the harness at the dog's middle back area and is secured by the integrated webbing strap handle which is stitched into the harness woven fabric.

4. The lightweight dog harness wrap of claim 1, wherein the harness wrap is manufactured with a durable woven nylon, mesh fabric, waterproof synthetic material, canvas, leather, or other organic or synthetic materials or combinations.

5. The lightweight dog harness wrap of claim 1, wherein the webbing strap handle is integrated along the length of the harness wrap and designed to provide load distribution of the leash pulling forces and forces exerted on the webbing strap across the woven fabric areas of the harness wrap.

6. The lightweight dog harness wrap of claim 1, wherein the harness wrap is secured and fitted to the dog by fully wrapping around the neck and wrapping around the dog's chest and torso area is secured with Velcro connection points.

7. The lightweight dog harness wrap of claim 1, wherein the integrated center of mass leash connection point may be used to secure the dog to an automobile seat belt.

8. A method for fitting and securing a lightweight dog harness wrap comprising:
wrapping a one piece X-shaped form-factor chest and torso area harness around the dog's middle torso and neck areas;
securing the four points of the harness X-shape with Velcro;
integrating a center of mass leash connection point for achieving load distribution geometry; and
integrating a nylon webbing handle along the top of the harness wrap;
wherein leash pulling forces are dissipated across the dog's center of mass, torso and chest areas and thereby eliminating choking at the neck; and wherein the harness wrap is constructed out of a durable, reversible, woven fabric, load bearing material for regulating the regulating the dog's body temperature in hot or cold environments and providing a secure, swaddle-fit enclosure for calming and protecting nervous or anxious dogs.

9. The method for fitting and securing a lightweight dog harness wrap of claim 8, wherein the four points of the harness X-shaped form-form factor design comprise two larger square shaped pieces which wrap around the dog's torso, chest and back areas and are secured with Velcro; and two smaller rounded angled forward shaped pieces which wrap around the dog's neck and are secured with Velcro.

10. The method for fitting and securing a lightweight dog harness wrap of claim 8, wherein the integrated center of mass leash connection point comprises a metal D-ring located at the top rear of the harness at the dog's middle back area and is secured by the integrated webbing strap handle which is stitched into the harness woven fabric.

11. The method for fitting and securing a lightweight dog harness wrap of claim 8, wherein the harness wrap is manufactured with a durable woven nylon, mesh fabric, waterproof synthetic material, canvas, leather, or other organic or synthetic materials or combinations.

12. The method for fitting and securing a lightweight dog harness wrap of claim 8, wherein the webbing strap handle is integrated along the length of the harness wrap and designed to provide load distribution of the leash pulling forces and forces exerted on the webbing strap across the woven fabric areas of the harness wrap.

13. The method for fitting and securing a lightweight dog harness wrap of claim 8, wherein the harness wrap is secured and fitted to the dog by fully wrapping around the neck and wrapping around the dog's chest and torso area is secured with Velcro connection points.

14. The method for fitting and securing a lightweight dog harness wrap of claim 8, wherein the integrated center of mass leash connection point may be used to secure the dog to an automobile seat belt.

15. A lightweight dog harness wrap comprising:
a one-piece woven fabric harness with middle torso and neck area fully wrapping load distributing design;
a center of mass integrated leash connection point; and
an integrated webbing handle strap;
wherein the leash pulling forces are dissipated across the dog's center of mass, torso, and chest areas and thereby eliminating choking at the neck; and wherein the harness wrap is constructed out of a durable, reversible, woven fabric, load bearing material for regulating the dog's body temperature in hot or cold environments and providing a secure, swaddle-fit enclosure for calming and protecting nervous or anxious dogs.

16. The lightweight dog harness wrap of claim 15, wherein the integrated center of mass leash connection point comprises a metal D-ring located at the top rear of the harness at the dog's middle back area and is secured by the integrated webbing strap handle which is stitched into the harness woven fabric.

17. The lightweight dog harness wrap of claim 15, wherein the harness wrap is manufactured with a durable woven nylon, mesh fabric, waterproof synthetic material, canvas, leather, or other organic or synthetic materials or combinations.

18. The lightweight dog harness wrap of claim 15, wherein the webbing strap handle is integrated along the length of the harness wrap and designed to provide load distribution of the leash pulling forces and forces exerted on the webbing strap across the woven fabric areas of the harness wrap.

19. The lightweight dog harness wrap of claim 15, wherein the harness wrap is secured and fitted to the dog by fully wrapping around the neck and wrapping around the dog's chest and torso area is secured with Velcro connection points.

20. The lightweight dog harness wrap of claim 15, wherein the integrated center of mass leash connection point may be used to secure the dog to an automobile seat belt.
